(19) United States
(12) Patent Application Publication
(10) Pub. No.: US 2017/0261113 A1
(43) Pub. Date: Sep. 14, 2017

(54) ELECTROMAGNETIC VALVE

(71) Applicant: HITACHI AUTOMOTIVE SYSTEMS, LTD., Hitachinaka-shi, Ibaraki (JP)

(72) Inventor: Yohei SATO, Utsunomiya-shi, Tochigi (JP)

(73) Assignee: HITACHI AUTOMOTIVE SYSTEMS, LTD., Hitachinaka-shi, Ibaraki (JP)

(21) Appl. No.: 15/505,676

(22) PCT Filed: Aug. 28, 2015
(86) PCT No.: PCT/JP2015/074402

§ 371 Date: Feb. 22, 2017

(30) Foreign Application Priority Data
Sep. 12, 2014 (JP) 2014-186934

(51) Int. Cl. F16K 27/02; F16K 31/06

(52) U.S. Cl. CPC F16K 27/029; F16K 31/0675

(57) ABSTRACT

There is provided an electromagnetic valve capable of ensuring a sufficient press-fit holding power when the electromagnetic valve is constructed by securing together a plurality of members by press-fitting. The electromagnetic valve of the present invention has a coil generating a magnetic field when energized, a cylinder comprising a cylindrical member of a non-magnetic material disposed at the inner periphery of the coil, a core provided at one end of the cylinder, a valve element disposed in the cylinder movably in the axial direction of the cylinder so that one end of the valve element faces the core, the valve element having a valve part at the other end thereof, a female press-fitting member having a cylindrical portion fluid-tightly connected to the cylinder, and a male press-fitting member having a seat part separable from the valve element, the male press-fitting member being press-fitted to the inside of the cylindrical portion of the female press-fitting member. The male press-fitting member has a rigidity lower than that of the female press-fitting member.

### TECHNICAL FIELD

The present invention relates to an electromagnetic valve suitable for use mainly in brake fluid pressure control devices.

### BACKGROUND ART

Patent Literature 1 discloses a known technique concerning electromagnetic valves. According to the patent publication, a seat member is press-fitted to a body in order to ensure the ease of working for forming an electromagnetic valve.

### CITATION LIST

### Patent Literature

Patent Literature 1: Japanese Patent Application Laid-Open Publication No. 2014-47862

### SUMMARY OF INVENTION

### Technical Problem

However, the press-fit holding power may become insufficient because the seat member has a larger sheet thickness than the body. The present invention has been made in view of the above-described problem, and an object of the present invention is to provide an electromagnetic valve capable of ensuring a sufficient press-fit holding power when the electromagnetic valve is constructed by securing together a plurality of members by press-fitting.

### Solution to Problem

To attain the above-described object, the present invention provides an electromagnetic valve in which a cylindrical male press-fitting member has a rigidity lower than that of a cylindrical female press-fitting member.

Accordingly, it is possible to ensure a press-fit holding power required for holding together the two members while reducing the tensile stress applied to the female press-fitting member.

### BRIEF DESCRIPTION OF DRAWINGS

FIG. 1 is a sectional view of an electromagnetic valve according to a first embodiment.

FIG. 2 is an enlarged sectional view of a plunger in the first embodiment.

FIG. 3 is an enlarged sectional view of an outer member in the first embodiment.

FIG. 4 is a sectional view showing the structure of an inner member in the first embodiment.

FIG. 5 is a diagram showing the sheet thickness relationship between the inner and outer members in a comparative example and the first embodiment when there are variations in sheet thickness.

FIG. 6 is a diagram showing the relationship between the internal stress and the sheet thickness in the comparative example and the first embodiment when the sheet thickness varies in the ranges shown in FIG. 5.

FIG. 7 is a sectional view of an electromagnetic valve according to a second embodiment.

FIG. 8 is a sectional view of an electromagnetic valve according to a third embodiment

FIG. 9 is a sectional view of an electromagnetic valve according to a fourth embodiment.

FIG. 10 is a sectional view of an electromagnetic valve according to a fifth embodiment.

### DESCRIPTION OF EMBODIMENTS

### First Embodiment

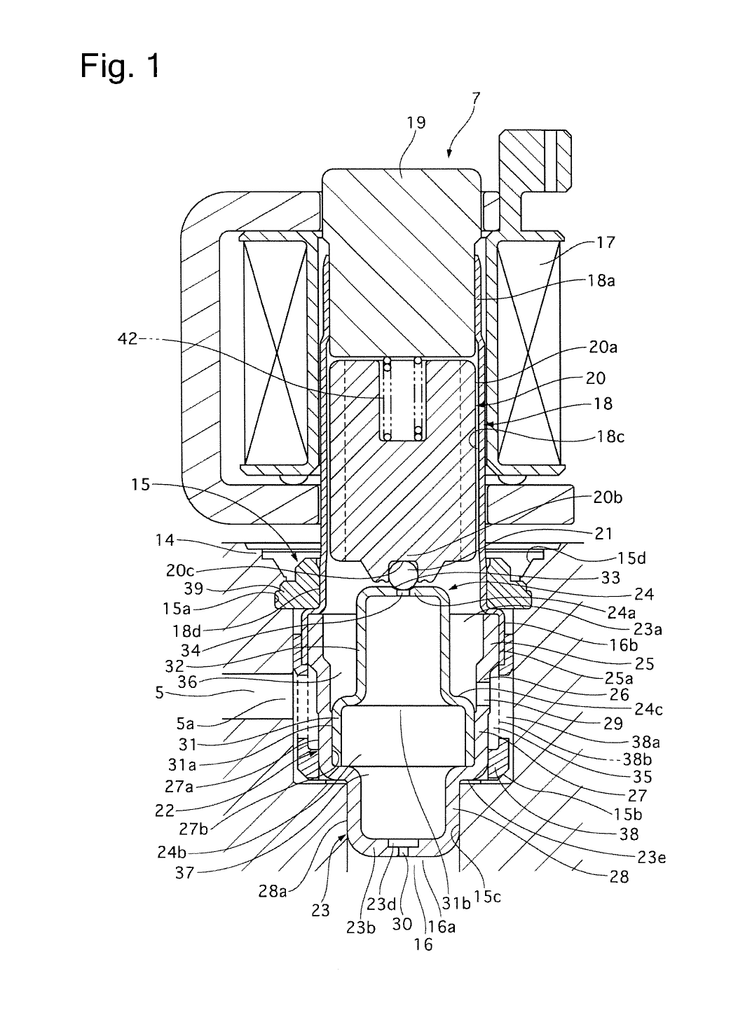

FIG. 1 is a sectional view of an electromagnetic valve according to a first embodiment. The electromagnetic valve is of normally-closed type which is closed when not energized. The electromagnetic valve mainly functions as a pressure-reducing valve in a brake circuit of a brake control device to reduce the wheel cylinder fluid pressure. The pressure-reducing valve 7 has a coil 17 generating electromagnetic force when energized, a cylinder 18 comprising a cylindrical member of a non-magnetic material disposed at the inner periphery of the coil 17, a core 19 provided at an upper end portion 18a of the cylinder 18 to function as a fixed iron core, a plunger 20 which is a movable member slidably accommodated in the cylinder 18, a ball-shaped valve element 21 provided at the distal end of the plunger 20, a valve spring 42 which is an urging member urging the plunger 20 in the advancing direction, and a seat member 22 having a seat part 33 that the valve element 21 separates from and rests on when the plunger 20 is caused to slide in the axial direction by the electromagnetic force of the coil 17 and the spring force of the valve spring 42.

The cylinder 18 has the core 19 secured to the upper end portion 18a by welding. A lower end portion 18b of the cylinder 18 is enlarged in diameter to form a stepped portion extending circumferentially outward. The cylinder 18 has a securing portion 18d formed above the stepped portion of the lower end portion 18b. An annular securing bush 39 is provided around the outer periphery of the securing portion 18d. The securing bush 39 is fitted over the securing portion 18d from the axially upper end of the core 19 and press-fitted to the outer peripheral surface of the securing portion 18d. A housing 14 has a valve holding hole 15 with a large-diameter portion 15a. The securing bush 39 is disposed in the large-diameter portion 15a. The upper end of the large-diameter portion 15a is staked to form a staked portion 15d. The staked portion 15d secures the securing bush 39 to the housing 14. The valve holding hole 15 has an intermediate-diameter portion 15b smaller in diameter than the large-diameter portion 15a and having an inner peripheral surface on which main passages 5 formed in the housing 14 open, and a small-diameter portion 15c smaller in diameter than the intermediate-diameter portion 15b and constituting reduced-pressure passages 16 formed in the housing 14.

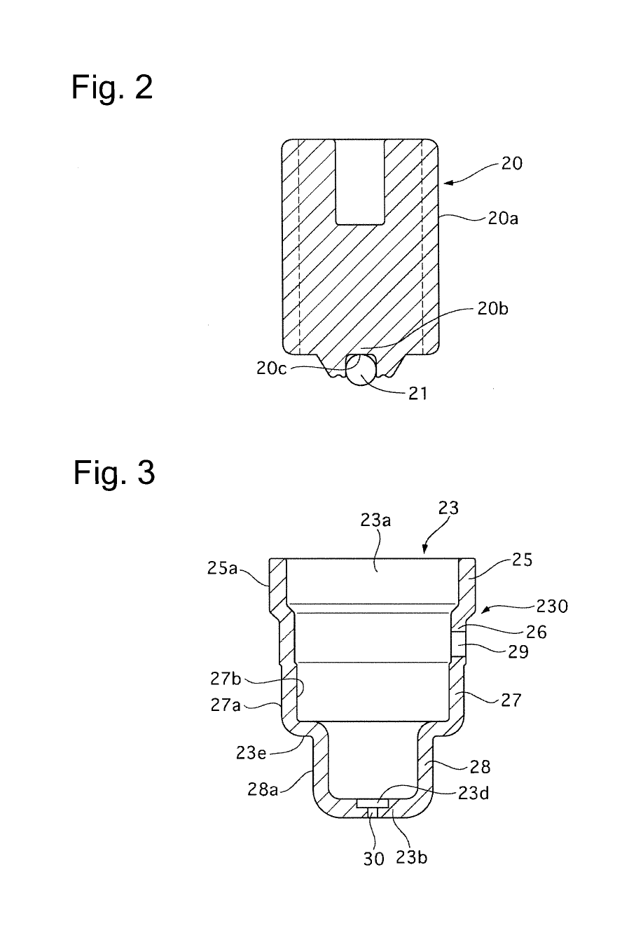

FIG. 2 is an enlarged sectional view of the plunger in the first embodiment. The plunger 20 is accommodated in the cylinder 18 so as to be slidable in the longitudinal direction while being guided at an outer peripheral surface 20a thereof by the inner peripheral surface of the cylinder 18. A lower end portion 20b of the plunger 20 is integrally formed with a bulged retaining groove 20c retaining the valve element 21. The plunger 20 has an axial length set relatively short so that the plunger 20 falls within the axial length of the cylinder 18. The valve element 21 is secured in the retaining groove 20c of the plunger 20 by staking. The valve spring 42 is compressively loaded between the seat surface of a columnar groove formed in the upper end of the plunger 20 and the lower surface of the core 19. The urging force of the valve spring 42 urges the plunger 20 axially toward the seat member 22, i.e. in the valve-closing direction. The seat member 22 has two members fitted to each other in the vertical direction (as seen in the figure), i.e. an outer member 23, which is a female press-fitting member, and an inner member 24, which is a male press-fitting member. The inner member 24 is pressed-fitted into the outer member 23 from the axial direction. Regarding the sheet thicknesses of the inner and outer members 24 and 23, the inner member 24 is formed thinner in sheet thickness than the outer member 23. The sheet thicknesses of these members will be detailed later.

FIG. 3 is an enlarged sectional view of the outer member in the first embodiment. The outer member 23 is formed in the shape of a bottomed cylinder by press forming. The outer member 23 has a first cylindrical wall 230. The first cylindrical wall 230 has, from the upper end side of the outer member 23 in FIG. 3 toward the lower end side thereof, a first peripheral wall 25 with a maximum diameter, a second peripheral wall 26 and third peripheral wall 27 with an intermediate diameter, and a fourth peripheral wall 28 with a minimum diameter. The first cylindrical wall 230 has a stepped configuration in which the first cylindrical wall 230 is successively reduced in diameter from a first opening portion 23a where one end of the outer member 23 on the side closer to the plunger 20 is open, toward a bottom portion 23b constituting a bottom wall.

The first peripheral wall 25 is press-fitted at an outer peripheral surface 25a thereof to the inner peripheral surface of the lower end portion 18b of the cylinder 18. The second peripheral wall 26 has a plurality of large-diameter passage holes 29 formed as through-holes in a side portion thereof. The large-diameter passage holes 29 are formed to extend through the second peripheral wall 26 in the radial direction.

The first peripheral wall 25 and the second peripheral wall 26 have their inner and outer peripheries formed in stepped configurations by press forming. The pressure of the press forming causes work hardening of the first and second peripheral walls 25 and 26. The work hardening increases the rigidity of the first and second peripheral walls 25 and 26. Accordingly, it is possible to suppress strain of the first peripheral wall 25 when the large-diameter passage holes 29 are formed.

The third peripheral wall 27 is formed with an outer diameter slightly smaller than that of the second peripheral wall 26. Meanwhile, the inner diameter of the third peripheral wall 27 is smaller than the inner diameters of the first and second peripheral walls 25 and 26. Further, the third peripheral wall 27 has the inner member 24 press-fitted to an inner peripheral surface 27b thereof. In addition, a cylindrical filter ring 38 is press-fitted to extend over from an outer peripheral surface 27a of the third peripheral wall 27 to the outer peripheral surface of the lower end portion 18b of the cylinder 18.

The bottom portion 23b has a small-diameter first passage hole 30 (opening) formed in the center to axially extend therethrough as an orifice. In addition, a recess 23d is formed at the top of the first passage hole 30. The first passage hole 30 and the recess 23d are formed as follows. First, the recess 23d, which is larger in inner diameter than the first passage hole 30, is formed in the inner bottom surface of the bottom portion 23b. Next, the first passage hole 30 is formed approximately in the center of the recess 23d as a through-hole extending through the bottom portion 23b. Accordingly, it is easy to perform an operation of forming the first passage hole 30 as a through-hole extending through the bottom portion 23b. Further, because the first passage hole 30 is formed in the bottom portion 23b of the outer member 23, formation of the first passage hole 30 is easier than forming orifices in the peripheral walls 25 to 28 to provide the first passage hole 30. Accordingly, it is possible to achieve an increase in productivity.

The filter ring 38 has a plurality of circumferentially spaced through-holes 38a. The through-holes 38a radially extend through the filter ring 38. The through-holes 38a each have a filter 38b for filtering a brake fluid. The filter ring 38 has a slight clearance between itself and the inner peripheral surface of the intermediate-diameter portion 15b of the valve holding hole 15 and one end opening 5a of each main passage 5. The space between the outer peripheral surfaces of the second and third peripheral walls 26 and 27 and the inner periphery of the filter ring 38 has a cylindrical first fluid passage 35 communicating with each main passage 5. The fourth peripheral wall 28 has an outer peripheral surface 28a press-fitted into the small-diameter portion 15c of the valve holding hole 15. Further, the outer member 23 has a stepped portion 23e between the third peripheral wall 27 and the fourth peripheral wall 28. A cylindrical press-fitting jig can be abutted against the stepped portion 23e from the axially lower end side of the outer member 23. Accordingly, when the outer member 23 is press-fitted into the cylinder 18, no pressure acts directly on the first passage hole 30 (explained later) in the bottom portion 23b or the surrounding area thereof. Consequently, it is possible to suppress deformation of the first passage hole 30 which may be caused by the pressure acting thereon. In addition, the inner periphery of the stepped portion 23e can be used as a stopper when the inner member 24 is press-fitted into the outer member 23, and thus assembly operability can be improved.

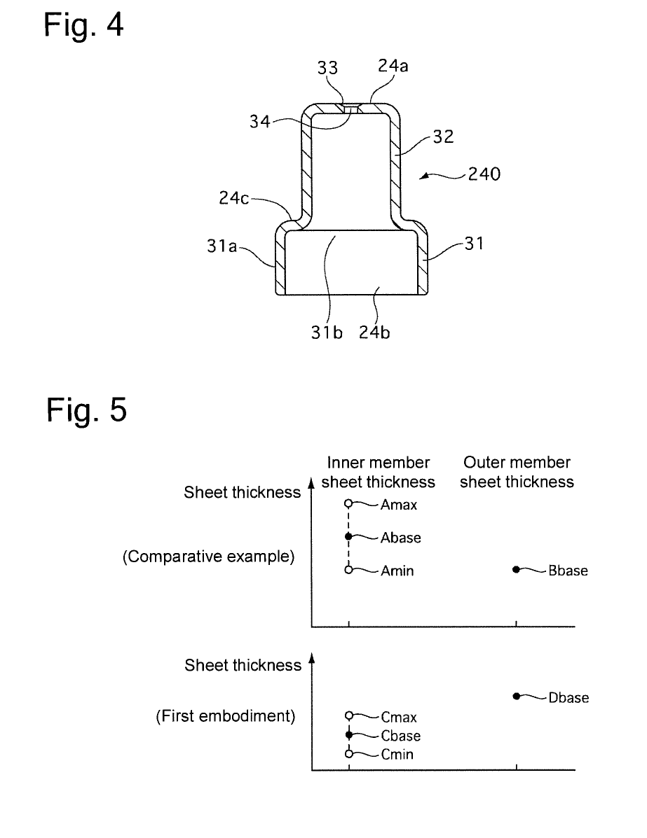

FIG. 4 is a sectional view showing the structure of the inner member in the first embodiment. The inner member 24 is formed in the shape of a lidded cylinder by press forming. It should be noted that the outer member 23 and the inner member 24 are press-formed from blanks (e.g. SUS305 stainless steel) of the same sheet thickness. Therefore, it is possible to reduce the number of varieties of blanks, and the manufacturing cost can be suppressed. In addition, the outer and inner members 23 and 24 are press-formed so that the inner member 24 is thinner in sheet thickness than the outer member 23 by adjusting the press force. Consequently, the inner member 24 is work-hardened and thus increased in rigidity. It should be noted that blanks for the outer and inner members 23 and 24 before press forming may be different in sheet thickness from each other. The inner member 24 has a second cylindrical wall 240. The second cylindrical wall 240 has, from the upper end side of the inner member 24 in FIG. 4 toward the lower end side thereof, a small-diameter portion 32 and a large-diameter portion 31 larger in diameter than the small-diameter portion 32. The second cylindrical wall 240 has a stepped configuration in which the second cylindrical wall 240 is successively reduced in diameter from a lid wall 24a which is a closed top located on the side closer to the plunger 20, toward a second opening portion 24b where the lower end of the inner member 24 is open.

The large-diameter portion 31 has an outer diameter smaller than the inner diameters of the first and second peripheral walls 25 and 26. The large-diameter portion 31 has an outer peripheral surface 31a press-fitted to the inner peripheral surface 27b of the third peripheral wall 27 of the outer member 23. The second opening portion 24b, which is at the lower end of the inner member 24, is disposed to face the first passage hole 30. A cylindrical second fluid passage 36 is formed in a space closed between the outer peripheral surface of the small-diameter portion 32 and the inner peripheral surfaces of the first and second peripheral walls 25 and 26 as well as the lower end of the plunger 20. The second fluid passage 36 communicates with the first fluid passage 35. The small-diameter portion 32 is smaller in both inner and outer diameters than the large-diameter portion 31. Accordingly, a wide space can be ensured for the second fluid passage 36.

In addition, a stepped portion 24c is formed between the large-diameter portion 31 and the small-diameter portion 32. When the inner member 24 is to be press-fitted to the inner peripheral surface 27b of the third peripheral wall 27 of the outer member 23, a press-fitting jig (not shown) is abutted against the stepped portion 24c. Accordingly, no pressure acts directly on the seat part 33 or the surrounding area thereof when the large-diameter portion 31 of the inner member 24 is press-fitted to the inner peripheral surface 27b of the third peripheral wall 27 of the outer member 23. Consequently, it is possible to suppress deformation of the seat part 33 which may be caused by the pressure acting directly on the seat part 33 or the surrounding area thereof.

The lid wall 24a at the upper end of the inner member 24 has a second passage hole 34 formed in the center thereof to vertically extend therethrough. The lid wall 24a further has a spherical seat part 33 formed along the upper end edge of the second passage hole 34. The seat part 33 has a tapered configuration in which the seat part 33 is gradually reduced in diameter toward the axis of the second passage hole 34. The seat part 33 is formed axially closer to the cylinder 18 than the large-diameter passage holes 29 of the outer member 23. When electromagnetic force of the coil 17 is applied thereto, the plunger 20 slides upward, and the valve element 21 separates from the seat part 33, thereby opening the second passage hole 34. When the electromagnetic force of the coil 17 is removed, the plunger 20 is slidingly moved downward by the spring force of the valve spring 42, and the valve element 21 rests on the seat part 33 to close the second passage hole 34. In addition, a third fluid passage 37 is formed in a space closed between the inner peripheral surface of the inner member 24 and the inner periphery of the fourth peripheral wall 28 of the outer member 23. When the second passage hole 34 is open, the brake fluid flowing out from the main passages 5 flows out to the two reduced-pressure passages 16 through the fluid passages 35 to 37.

In the first embodiment, the seat member 22 comprises two members, i.e. the outer member 23 and the inner member 24, and the seat part 33 of the inner member 24 is formed at a position axially closer to the cylinder 18 than the large-diameter passage holes 29 of the outer member 23. Accordingly, it is possible to reduce the overall length of the plunger 20 from the core 19-side end surface of the plunger 20 to the valve element 21. Further, the plunger 20 is always guided (supported) at the entire outer peripheral surface 20a by the inner peripheral surface 18c of the cylinder 18. Therefore, even if the plunger 20 tilts when sliding in the cylinder 18 due to the clearance between the inner peripheral surface of the cylinder 18 and the outer peripheral surface of the plunger 20, it is possible to suppress displacement of the valve seating point of the valve element 21 when abutting against the seat part 33 to close the pressure-reducing valve 7.

Further, in the first embodiment, the seat member 22 comprises two members, i.e. the outer member 23 and the inner member 24, so that the seat part 33 of the inner member 24 and the fourth peripheral wall 28 of the outer member 23, which is press-fitted to the housing, are distinct parts, separate from each other. Therefore, the fourth peripheral wall 28, which is press-fitted into the small-diameter portion 15c of the valve holding hole 15, and the seat part 33, on which the valve element 21 is abutted, are spaced apart from each other, and the seat part 33 is disposed in close proximity to the plunger 20. Accordingly, the seat part 33 will not be affected by deformation due to press-fitting. In this regard also, the valve seating point of the valve element 21 is unlikely to be displaced when the valve element 21 is seated on the seat part 33, and it is possible to suppress degradation of the sealing performance of the valve element 21.

Further, the third peripheral wall 27 of the outer member 23 is formed with a stepped configuration between itself and the fourth peripheral wall 28, as has been stated above. That is, if the third peripheral wall 27 and the fourth peripheral wall 28 were formed in the same plane, an outwardly expanding force would be applied to the third and fourth peripheral walls 27 and 28 by press-fitting of the inner member 24, resulting in an excessively large press-fit load being applied to the housing 14. In contrast, in the first embodiment, the third peripheral wall 27 press-fitted with the inner member 24 and the fourth peripheral wall 28 press-fitted into the housing 14 are formed in a stepped configuration. Consequently, the outer member 23 is work-hardened, and press-fitting of the inner member 24 will not outwardly expand the fourth peripheral wall 28 of the outer member 23. It is therefore possible to suppress the press-fit load from becoming excessively large.

Further, the outer peripheral surface 31a of the large-diameter portion 31 of the inner member 24, which is provided with the seat part 33, is press-fitted to the inner peripheral surface 27b of the third peripheral wall 27 of the outer member 23. Thus, the seat part 33 cannot accidentally move in the axial direction; therefore, it is possible to improve sealing performance when the valve element 21 of the plunger 20 is abutted against the seat part 33 by the urging force of the valve spring 42 to close the pressure-reducing valve 7.

Further, a cost reduction can be achieved by using press forming to form the outer member 23 and the inner member 24. Further, as has been stated above, the large-diameter portion 31 has an outer diameter smaller than the inner diameters of the first and second peripheral walls 25 and 26, and the outer peripheral surface 31a is press-fitted to the inner peripheral surface 27b of the third peripheral wall 27 of the outer member 23. In addition, the second opening portion 24b at the lower end of the inner member 24 is disposed to face the first passage hole 30. Accordingly, it is possible to improve press-fitting operability when the large-diameter portion 31 of the inner member 24 is press-fitted to the inner peripheral surface 27b of the third peripheral wall 27 because the first and second peripheral walls 25 and 26 do not have the same inner diameter as that of the third peripheral wall 27 and therefore the axial range of portions to be press-fitted is reduced. Further, because portions to be press-fitted are limited, it is possible to reduce areas that need to be finished. Specifically, the outer peripheral surface 25a of the first peripheral wall 25 needs to be finished because the outer peripheral surface 25a is press-fitted to the inner peripheral surface of the lower end portion 18b of the cylinder 18. However, it is unnecessary to finish the inner peripheral surfaces of the first and second peripheral walls 25 and 26 because portions to be press-fitted are limited as stated above. Consequently, productivity can be improved. Further, because the outer member 23 is fluid-tightly press-fitted to the housing 14, sealing can be achieved without using an O-ring.

(Regarding the Sheet Thickness Relationship Between the Outer Member and the Inner Member)

In the electromagnetic valve of the first embodiment, the inner member 24 is thinner in sheet thickness than the outer member 23. Specifically, the outer member 23 has a sheet thickness of about 0.8 mm, and the inner member 24 has a sheet thickness of about 0.6 mm. The sheet thickness of a cylindrical member is correlated with the rigidity in the radial direction of the cylindrical member. In general, the following can be said for members formed from the same blank, the larger the sheet thickness, the higher the radial rigidity; the smaller the sheet thickness, the lower the radial rigidity. Further, when two cylindrical members are fixed together by press-fitting one cylindrical member to the inner periphery of the other, the press-fit holding power is determined by the strength of one of the two members that is lower in rigidity than the other.

If the outer member 23 is thinner in sheet thickness than the inner member 24 (this hypothetical example will hereinafter be referred to as the “comparative example”), the press-fit holding power of the outer and inner members 23 and 24 as secured together by press-fitting is determined by the strength of the outer member 23. Therefore, even if the rigidity of the inner member 24 is increased to ensure the positional accuracy of the seat part 33 and to suppress the deformation of the seat part 33, no sufficient press-fit holding power can be obtained due to a lack of rigidity of the outer member 23. Consequently, when a load acts on the inner member 24 as the high-pressure brake fluid flows, the inner member 24 cannot be held firmly, and hence the inner member 24 cannot be held stably in position. It is necessary, in order to ensure a sufficient press-fit holding power, to increase the area of contact between the outer member 23 and the inner member 24. In this case, an increase in the area of contact leads to an increase in size in the axial or radial direction.

In general, compressive strength is higher than tensile strength when compared with the same blank. When the inner member 24 is press-fitted into the outer member 23, a tensile force is applied to the outer member 23, and a compressive force is applied to the inner member 24. Accordingly, in order to ensure the tensile strength necessary for the outer member 23, both the outer member 23 and the inner member 24 need to be increased in sheet thickness, which may result in issues such as an increase in material cost and degradation of the ease of working.

Under these circumstances, in the first embodiment, the outer member 23 is formed thicker in sheet thickness than the inner member 24. In other words, the inner member 24 is formed thinner in sheet thickness than the outer member 23. In this case, the press-fit holding power is determined by the rigidity of the inner member 24, which is a lower rigidity member. The inner member 24 is subjected to a compressive force; therefore, a higher press-fit holding power can be ensured than in a case where the lower rigidity member is subjected to a tensile force, for the same sheet thickness. Accordingly, there is no need to ensure an extra sheet thickness, and it is possible to achieve size and weight reductions. In addition, it is possible to suppress the material cost when producing the electromagnetic valve and also possible to improve the ease of working. It should be noted that the outer member 23 is press-fitted to the housing 14 while receiving a compressive force at the fourth peripheral wall 28, which is a part of the outer member 23, and the inner member 24 is press-fitted thereinto while receiving a tensile force at the inner peripheral surface 27b of the third peripheral wall 27. Therefore, it is desirable to set a sheet thickness corresponding to both the compressive and tensile forces.

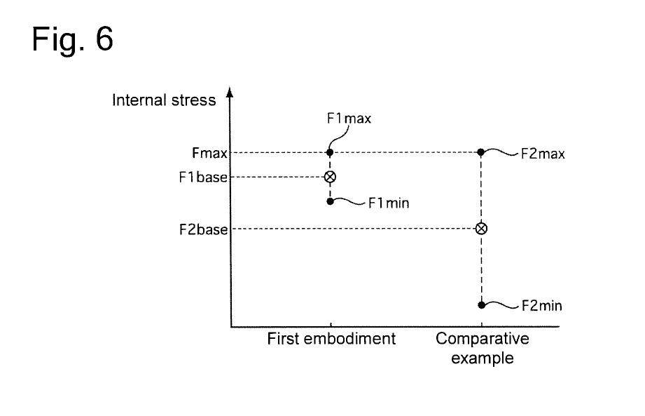

Next, let us pay attention to variations in manufacture. FIG. 5 is a diagram showing the sheet thickness relationship between the inner and outer members in the comparative example and the first embodiment when there are variations in sheet thickness. Let us assume as follows: the design value of the sheet thickness of the inner member in the comparative example is Abase; the maximum variation sheet thickness is Amax; the minimum variation sheet thickness is Amin; and the design value of the sheet thickness of the outer member is Bbase. Similarly, the design value of the sheet thickness of the inner member in the first embodiment is Cbase; the maximum variation sheet thickness is Cmax; the minimum variation sheet thickness is Cmin; and the design value of the sheet thickness of the outer member is Dbase. It should be noted that the outer member may vary in sheet thickness; however, the sheet thickness variation of the outer member is disregarded in the following discussion for comparison purposes. FIG. 6 is a diagram showing the relationship between the internal stress and the sheet thickness in the comparative example and the first embodiment when the sheet thickness varies in the ranges shown in FIG. 5. It should be noted that the relationship between the outer member sheet thickness and the inner member sheet thickness is set so that the maximum internal stresses Fmax in the first embodiment and the comparative example are coincident with each other. As shown in FIG. 6, the amount of separation between the maximum internal stress F1max and the minimum internal stress F1min in the first embodiment is smaller than the amount of separation between the maximum internal stress F2max (=F1max) and the minimum internal stress F2min in the comparative example.

The reason for the above is because the sensitivity to the internal stress when the sheet thickness varies in a region where the sheet thickness is large is higher than the sensitivity to the internal stress when the sheet thickness varies in a region where the sheet thickness is small. In other words, when the sheet thickness of the inner member varies toward Amin in a region where the sheet thickness is large as in the comparative example, the internal stress is likely to decrease considerably. In contrast, in the first embodiment, even if the sheet thickness of the inner member varies toward Cmin, the internal stress does not decrease so much as in the comparative example. In the product designing, the median value of these variations is used. Therefore, in the first embodiment, the median value F1base between F1max and F1min is the design value. Similarly, in the comparative example, the median value F2base between F2max and F2min is the design value. In this case, the internal stress variation is larger in the comparative example than in the first embodiment; therefore, the median value F2base in the comparative example is inevitably lower than the median value F1base in the first embodiment. In the comparative example, in order to obtain the same design value as F1base in the first embodiment, it is necessary to design both the inner member and the outer member to increase in sheet thickness to thereby raise F2base to F1base. Accordingly, problems such as an increase in material cost and degradation of the ease of working are likely to arise. In contrast, in the first embodiment, a high press-fit holding power can be ensured with a reduced sheet thickness, so that the material cost can be suppressed, and the ease of working can be ensured. In addition, it is possible to suppress variations in internal stress and hence possible to achieve stabilized performance. In addition, because a high press-fit holding power can be obtained, sealing performance by press-fitting is also improved.

### Advantages of First Embodiment

The following is a list of advantages of the electromagnetic valve mentioned in the first embodiment:

(1-1) There is provided an electromagnetic valve that comprises a coil 17 generating a magnetic field when energized, a cylinder 18 comprising a cylindrical member of a non-magnetic material disposed at the inner periphery of the coil 17, a core 19 provided at one end of the cylinder 18, a valve element 21 disposed in the cylinder 18 movably in the axial direction of the cylinder 18 so that one end of the valve element 21 faces the core 19, the valve element 21 having a valve part at the other end thereof, an outer member 23 having a first cylindrical wall 230, the outer member 23 being connected to the cylinder 18 at one end thereof and having an opening at the other end thereof, and an inner member 24 having a second cylindrical wall 240 press-fitted to an inner surface of the first cylindrical wall 230 at at least a part of an outer surface thereof formed at one end thereof, the inner member 24 having at the other end thereof a seat part 33 separable from the valve element 21, the second cylindrical wall 240 having a thin-walled portion thinner in wall thickness than the outer member 23. Accordingly, it is possible to ensure a press-fit holding power necessary for holding together the outer and inner members 23 and 24 while reducing the tensile stress applied to the outer member 23, which is a female press-fitting member. It should be noted that although in the first embodiment the first cylindrical wall 230 is formed in the shape of a cylindrical wall, the shape of the first cylindrical wall 230 is not limited to a cylinder but may be a polygonal cylinder, a ribbed cylinder, etc. Further, it suffices to make the radial rigidity of the inner member 24 lower than that of the outer member 23. Therefore, even if the outer member 23 and the inner member 24 have the same sheet thickness, a required difference in rigidity can be obtained, for example, by devising the configuration of the first cylindrical wall 230 or the second cylindrical wall 240.

(2-2) In the electromagnetic valve as set forth in the above (1-1), the thin-walled portion is formed on at least a part of the second cylindrical wall 240. Accordingly, it is possible to reduce an excessive tensile stress applied to the outer member 23. It should be noted that although in the first embodiment the whole second cylindrical wall 240 is formed thinner in sheet thickness than the first cylindrical wall 230 of the outer member, only a part of the second cylindrical wall 240 that is subjected to a radial compressive force may be formed thinner in sheet thickness than the first cylindrical wall 230. In this case, it is possible to ensure rigidity for the seat part and so forth while reducing an excessive tensile stress applied to the outer member 23.

(3-3) In the electromagnetic valve as set forth in the above (2-2), the thin-walled portion is formed on a part of the second cylindrical wall 240 that is to be press-fitted. Accordingly, it is possible to reduce an excessive tensile stress applied to the outer member 23.

(4-4) In the electromagnetic valve as set forth in the above (3-3), the thin-walled portion is formed over the entire circumference of the second cylindrical wall 240. Accordingly, press-fit holding power can be exhibited over the entire circumference. Thus, stable holding power can be obtained.

(5-5) In the electromagnetic valve as set forth in the above (1-1), the inner member 24 is formed by press-forming a sheet member. Accordingly, formability can be improved.

(6-6) In the electromagnetic valve as set forth in the above (5-5), the sheet member is work-hardened by press forming. Accordingly, it is possible to obtain a seat part 33 of high hardness when forming the sheet member.

(7-7) In the electromagnetic valve as set forth in the above (1-1), the inner member 24 is reduced in rigidity in the compression direction of the inner member 24 by the thin-walled portion. By reducing the rigidity with the second cylindrical wall 240, which is a thin-walled portion, a tensile stress applied to the outer member 23 can be reduced, and it is possible to ensure holding power when the inner member 24 is press-fitted into the outer member 23.

(8-8) In the electromagnetic valve as set forth in the above (1-1), the outer member 23 and the inner member 24 are formed by using the same blank. That is, the sheet thickness is adjusted when each member is press-formed from the same blank, thereby making it possible to reduce the number of varieties of blanks, and to reduce the manufacturing cost.

(9-9) In the electromagnetic valve as set forth in the above (1-1), the electromagnetic valve has a valve spring 42 (urging member) compressively loaded between the valve element 21 and the core 19 to urge the valve element 21 against the seat part 33. The outer member 23 is formed in the shape of a bottomed cylinder and fluid-tightly connected to the cylinder 18 at the opening end thereof. The outer member 23 has a first passage hole 30 (first fluid passage) formed in the bottom portion thereof and a large-diameter passage hole 29 (second fluid passage) formed in the cylindrical wall thereof. An outer surface is press-fitted to the inner surface of the first cylindrical wall 230 (cylindrical wall of the outer member 23). A second passage hole 34 (communicating passage) providing communication between the first passage hole 30 and the large-diameter passage hole 29 is provided in the bottom portion. A seat part 33 with which the valve element 21 is capable of coming in and out of contact to close and open the second passage hole 34 is provided on the bottom portion. Accordingly, it is possible to obtain a normally-closed electromagnetic valve capable of attaining a stable cut-off state when the coil 17 is not energized (i.e. favorable in holdability).

(10-10) There is provided an electromagnetic valve that comprises a coil 17 generating a magnetic field when energized, a cylinder 18 comprising a cylindrical member of a non-magnetic material disposed at the inner periphery of the coil 17, a core 19 provided at one end of the cylinder 18, a valve element 21 disposed in the cylinder 18 movably in the axial direction of the cylinder 18 so that one end of the valve element 21 faces the core 19, the valve element 21 having a valve part at the other end thereof, an outer member 23 having a first cylindrical wall 230 which is a cylindrical wall, the outer member 23 being connected to the cylinder 18 at one end thereof and having an opening at the other end thereof, and an inner member 24 having a second cylindrical wall 240 which is a cylindrical wall press-fitted to an inner surface of the first cylindrical wall 230 at at least a part of an outer surface thereof formed at one end thereof, the inner member 24 having at the other end thereof a seat part 33 separable from the valve element 21, the inner member 24 having a radial rigidity lower than that of the outer member 23. Accordingly, it is possible to ensure a press-fit holding power necessary for holding together the outer and inner members 23 and 24 while reducing the tensile stress applied to the outer member 23, which is a female press-fitting member. In addition, because the first and second cylindrical walls 230 and 240 are cylindrical walls, a stable press-fit holding power can be ensured, and stress concentration after press-fitting can be suppressed. In addition, because the first and second cylindrical walls 230 and 240 are cylindrical walls, manufacture is easy.

(11-11) In the electromagnetic valve as set forth in the above (10-10), the second cylindrical wall 240 (cylindrical wall) of the inner member 24 has a thin-walled portion thinner in wall thickness than the first cylindrical wall 230 (cylindrical wall) of the outer member 23. Accordingly, rigidity can be easily adjusted by varying the sheet thickness.

(12-12) In the electromagnetic valve as set forth in the above (11-11), the thin-walled portion is formed on at least a part of the second cylindrical wall 240 (cylindrical wall of the inner member). Accordingly, rigidity can be easily adjusted by varying the sheet thickness. It should be noted that although in the first embodiment the whole second cylindrical wall 240 is formed thinner in sheet thickness than the first cylindrical wall 230 of the outer member, only a part of the second cylindrical wall 240 that is subjected to a radial compressive force may be formed thinner in sheet thickness than the first cylindrical wall 230. In this case, it is possible to ensure rigidity for the seat part and so forth while reducing an excessive tensile stress applied to the outer member 23.

(13-13) In the electromagnetic valve as set forth in the above (12-12), the thin-walled portion is formed on a part of the second cylindrical wall 240 of the inner member 24 that is to be press-fitted. The tensile stress applied to the outer member 23 can be reduced effectively by reducing the wall thickness of a part of the second cylindrical wall 240 that is to be press-fitted.

(14-15) In the electromagnetic valve as set forth in the above (10-10), the thin-walled portion is formed over the entire circumference of a part of the second cylindrical wall 240 (cylindrical wall of the inner member) that is to be press-fitted. Accordingly, press-fit holding power can be exhibited over the entire circumference. Thus, stable holding power can be obtained.

(15-16) In the electromagnetic valve as set forth in the above (10-10), the electromagnetic valve has a valve spring 42 (urging member) compressively loaded between the valve element 21 and the core 19 to urge the valve element 21 against the seat part 33. The outer member 23 is formed in the shape of a bottomed cylinder and fluid-tightly connected to the cylinder 18 at the opening end thereof. The outer member 23 has a first passage hole 30 (first fluid passage) formed in the bottom portion thereof and a large-diameter passage hole 29 (second fluid passage) formed in the cylindrical wall thereof. An outer surface is press-fitted to the inner surface of the first cylindrical wall 230 (cylindrical wall) of the outer member 23. A second passage hole 34 (communicating passage) providing communication between the first passage hole 30 and the large-diameter passage hole 29 is provided in the bottom portion thereof. A seat part 33 with which the valve element 21 is capable of coming in and out of contact to close and open the second passage hole 34 is provided on the bottom portion thereof. Accordingly, it is possible to obtain a normally-closed electromagnetic valve capable of attaining a stable cut-off state when the coil 17 is not energized (i.e. favorable in holdability).

(16-17) There is provided an electromagnetic valve that comprises a coil 17 generating a magnetic field when energized, a cylinder 18 comprising a cylindrical member of a non-magnetic material disposed at the inner periphery of the coil 17, a core 19 provided at one end of the cylinder 18, a valve element 21 disposed in the cylinder 18 movably in the axial direction of the cylinder 18 so that one end of the valve element 21 faces the core 19, the valve element 21 having a valve part at the other end thereof, an outer member 23 which is a female press-fitting member, the outer member 23 having a first cylindrical wall 230 fluid-tightly connected to the cylinder 18, and an inner member 24 having a second cylindrical wall 240 having a seat part 33 capable of coming in and out of contact with the valve element 21, the second cylindrical wall 240 being press-fitted to the first cylindrical wall 230. In the electromagnetic valve, the first cylindrical wall 230 has a rigidity lower than that of the second cylindrical wall 240. Accordingly, it is possible to ensure a press-fit holding power necessary for holding the outer and inner members 23 and 24 while reducing the tensile stress applied to the outer member 23, which is a female press-fitting member.

### Second Embodiment

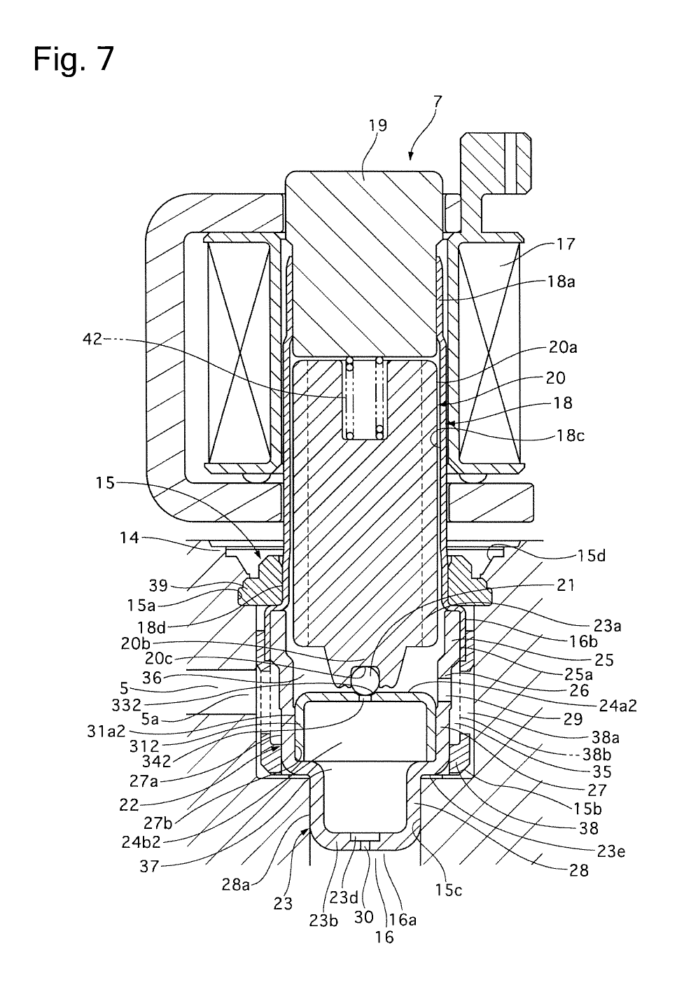

Next, a second embodiment will be explained. The basic structure of the second embodiment is the same as that of the first embodiment; therefore, only the points in which the second embodiment differs from the first embodiment will be explained. FIG. 7 is a sectional view of an electromagnetic valve of the second embodiment. The inner member 24 has a second cylindrical wall 312 and a lid wall 24a2 which is a closed top located on the side closer to the plunger 20. The second cylindrical wall 312 has an outer diameter smaller than the inner diameters of the first and second peripheral walls 25 and 26. The second cylindrical wall 312 has an outer peripheral surface 31a2 press-fitted to the inner peripheral surface 27b of the third peripheral wall 27 of the outer member 23. The inner member 24 has a second opening portion 24b2 at the lower end thereof. The second opening portion 24b2 is disposed to face the first passage hole 30.

The lid wall 24a2 at the upper end of the inner member 24 has a second passage hole 342 formed in the center thereof to vertically extend therethrough. The lid wall 24a2 further has a spherical seat part 332 formed along the upper end edge of the second passage hole 342. The seat part 332 has a tapered configuration in which the seat part 332 is gradually reduced in diameter toward the axis of the second passage hole 342. The seat part 332 is formed axially closer to the reduced-pressure passages 16 than the large-diameter passage holes 29 of the outer member 23. When electromagnetic force of the coil 17 is applied thereto, the plunger 20 slides upward, and the valve element 21 separates from the seat part 332, thereby opening the second passage hole 342. When the electromagnetic force of the coil 17 is removed, the plunger 20 is slidingly moved downward by the spring force of the valve spring 42, and the valve element 21 rests on the seat part 332 to close the second passage hole 34. In addition, a third fluid passage 37 is formed in a space closed by the inner peripheral surface of the inner member 24 and the inner periphery of the fourth peripheral wall 28 of the outer member 23. When the second passage hole 342 is open, the brake fluid flowing out from the main passages 5 flows out to the two reduced-pressure passages 16 through the fluid passages 35 to 37.

In the second embodiment also, the outer member 23 has a sheet thickness larger than that of the inner member 24 in the same way as in the first embodiment. In other words, the inner member 24 has a sheet thickness smaller than that of the outer member 23. Accordingly, there is no need to ensure an extra sheet thickness, and it is possible to achieve size and weight reductions. In addition, it is possible to suppress the material cost when producing the electromagnetic valve and also possible to improve the ease of working.

### Third Embodiment

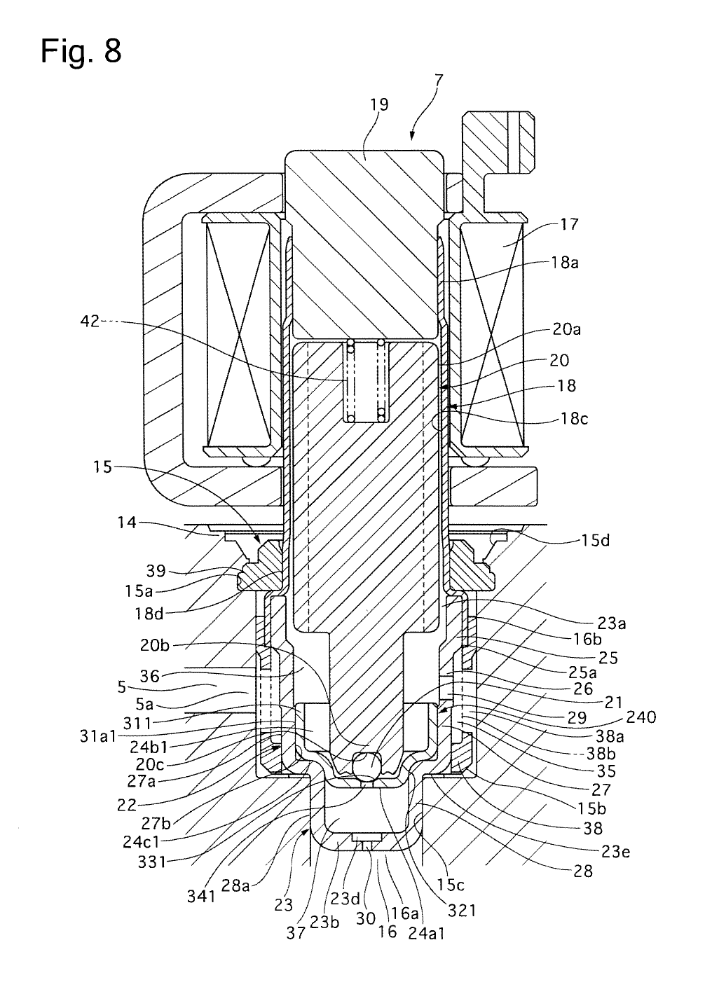

Next, a third embodiment will be explained. The basic structure of the third embodiment is the same as that of the first embodiment; therefore, only the points in which the third embodiment differs from the first embodiment will be explained. FIG. 8 is a sectional view of an electromagnetic valve of the third embodiment. The inner member 24 has a second cylindrical wall 240. The second cylindrical wall 240 has, from the upper end side of the inner member 24 in FIG. 8 toward the lower end side thereof, a large-diameter portion 311 and a small-diameter portion 321 smaller in diameter than the large-diameter portion 311. The second cylindrical wall 240 has a stepped configuration in which the second cylindrical wall 240 is successively enlarged in diameter from a bottom wall 24a1 which is a closed bottom located on the side closer to the reduced-pressure passages 16, toward a second opening portion 24b1 where the upper end of the inner member 24 is open.

The small-diameter portion 321 has an outer diameter smaller than the inner diameter of the fourth peripheral wall 28. The large-diameter portion 311 has an outer peripheral surface 31a1 press-fitted to the inner peripheral surface 27b of the third peripheral wall 27 of the outer member 23. The second opening portion 24b1 at the upper end of the inner member 24 is disposed to face the plunger 20. Further, the second cylindrical wall 240 has a stepped portion 24c1 between the large-diameter portion 31 and the small-diameter portion 32. When the inner member 24 is to be press-fitted to the inner peripheral surface 27b of the third peripheral wall 27 of the outer member 23, a press-fitting jig (not shown) is abutted against the stepped portion 24c. Accordingly, when the large-diameter portion 31 of the inner member 24 is press-fitted to the inner peripheral surface 27b of the third peripheral wall 27 of the outer member 23, no pressure acts directly on a seat part 331 or the surrounding area thereof. Consequently, it is possible to suppress deformation of the seat part 331 which may be caused by the pressure acting directly on the seat part 331 or the surrounding area thereof.

The bottom wall 24a1 at the lower end of the inner member 24 has a second passage hole 341 formed in the center thereof to vertically extend therethrough. The bottom wall 24a1 further has a spherical seat part 331 formed along the upper end edge of the second passage hole 341. The seat part 331 has a tapered configuration in which the seat part 331 is gradually reduced in diameter toward the axis of the second passage hole 34. The seat part 331 is formed axially closer to the reduced-pressure passages 16 than the large-diameter passage holes 29 of the outer member 23. When electromagnetic force of the coil 17 is applied thereto, the plunger 20 slides upward, and the valve element 21 separates from the seat part 331, thereby opening the second passage hole 341. When the electromagnetic force of the coil 17 is removed, the plunger 20 is slidingly moved downward by the spring force of the valve spring 42, and the valve element 21 rests on the seat part 33 to close the second passage hole 341. In addition, a third fluid passage 37 is formed in a space closed by the outer peripheral surface of the small-diameter portion 321 of the inner member 24 and the inner periphery of the fourth peripheral wall 28 of the outer member 23. When the second passage hole 34 is open, the brake fluid flowing out from the main passages 5 flows out to the two reduced-pressure passages 16 through the fluid passages 34 and 37.

In the third embodiment also, the outer member 23 has a sheet thickness larger than that of the inner member 24 in the same way as in the first embodiment. In other words, the inner member 24 has a sheet thickness smaller than that of the outer member 23. Accordingly, there is no need to ensure an extra sheet thickness, and it is possible to achieve size and weight reductions. In addition, it is possible to suppress the material cost when producing the electromagnetic valve and also possible to improve the ease of working. In addition, because the inner member 24 has a stepped configuration, the large-diameter portion 311 and the small-diameter portion 321 are work-hardened by the pressure applied thereto by press forming. The work hardening increases the rigidity of the large-diameter portion 311 and the small-diameter portion 321. Accordingly, it is possible to suppress strain of the seat part 331.

### Fourth Embodiment

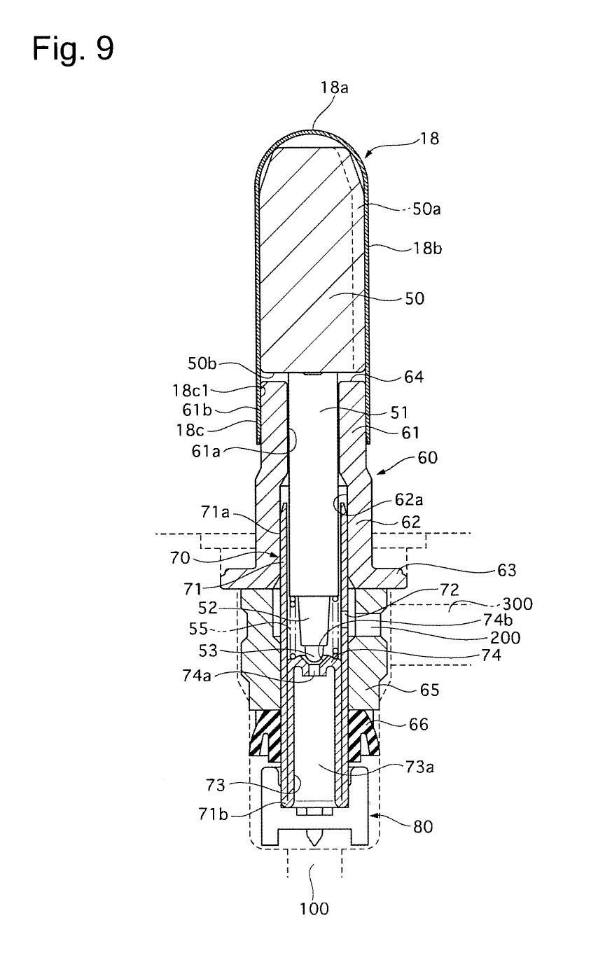

Next, a fourth embodiment will be explained. FIG. 9 is a sectional view of an electromagnetic valve of the fourth embodiment. The first embodiment shows an example in which the present invention is applied to a normally-closed electromagnetic valve; in the fourth embodiment, the present invention is applied to a normally-open electromagnetic valve that is open when not energized. It should be noted that although no coil of an electromagnetic valve is shown in FIG. 9, a coil is installed around the outer periphery of a cylinder when the illustrated structure is actually used to function as an electromagnetic valve. The electromagnetic valve mainly functions as a pressure-increasing valve in a brake circuit of a brake control device to increase the wheel cylinder fluid pressure. The pressure-increasing valve has a coil (not shown) generating electromagnetic force when energized, a cylinder 18 comprising a cylindrical member of a non-magnetic material disposed at the inner periphery of the coil, an electromagnetic valve body 60 provided at a lower end portion 18c of the cylinder 18 to function as a fixed iron core, a plunger 50 which is a movable member slidably accommodated in the cylinder 18, a valve element 53 with a ball-shaped distal end which is provided at the distal end of the plunger 50, a valve spring 55 which is an urging member urging the plunger 50 in the valve-opening direction, and a seat member 70 having a seat part 74b that the valve element 53 rests on and separates from when the plunger 50 is caused to slide in the axial direction by the electromagnetic force of the coil and the spring force of the valve spring 55.

The cylinder 18 is closed at the upper end thereof in the shape of a dome and open at the lower end thereof. The electromagnetic valve body 60 is secured to a lower end portion 18c of the cylinder 18 by welding. The plunger 50 is axially slidably installed in a cylindrical portion 18b of the cylinder 18. The plunger 50 has a core member 50a, a shaft portion 51 smaller in diameter than the core member 50a and connected to the lower end of the core member 50a, and a distal end portion 52 smaller in diameter than the shaft portion 51 and having the valve element 53 at the distal end thereof. The core member 50a has a magnetic attraction surface 50b formed on a lower end surface thereof around the outer periphery of the shaft portion 51. The magnetic attraction surface 50b is formed at a position facing an upper end surface 64 of the electromagnetic valve body 60. When the coil is energized, a magnetic field is generated, which in turn generates an electromagnetic attraction force between the plunger 50 and the electromagnetic valve body 60.

The electromagnetic valve body 60 has a body upper portion 61b welded to the cylinder 18, a body lower portion 62 enlarged in diameter as compared with the body upper portion 61b, and a body securing portion 63 for securing the electromagnetic valve body 60 to the housing by staking. The body upper portion 61b has a holding hole 61a formed at the inner periphery thereof to slidably hold the shaft portion 51. The body lower portion 62 has a female press-fitting hole 62a formed at the inner periphery thereof. The female press-fitting hole 62a is enlarged in diameter as compared with the holding hole 61a. The electromagnetic valve body 60 has an opening at the end of the female press-fitting hole 62a. The electromagnetic valve body 60 is an outer member, and the body lower portion 62 forms a first cylindrical wall. The electromagnetic valve has a substantially cylindrical second body 65 underneath the electromagnetic valve body 60. The second body 65 has a cylindrical wall capable of receiving a seat member 70 therein. The seat member 70 can extend through the cylindrical wall. The cylindrical wall has a second body radial fluid passage 200 radially extending therethrough. The electromagnetic valve has a seal member 66 underneath the second body 65. The seal member 66 fluid-tightly seals between a master cylinder-side fluid passage 100 and a wheel cylinder-side fluid passage 300. Further, the electromagnetic valve has a filter member 80 underneath the seal member 66 at the lower end of the seat member 70. The filter member 80 filters the brake fluid flowing in from the master cylinder-side fluid passage 100.

The seat member 70 has a sheet thickness smaller than that of the electromagnetic valve body 60 and is formed by press forming. The seat member 70 has an outer cylindrical portion 71 to be press-fitted into the female press-fitting hole 62a, a folded-back portion 71b folded back inward of the outer cylindrical portion 71 at the lower end of the latter, an inner cylindrical portion 73 folded back to extend along the inner periphery of the outer cylindrical portion 71, and a lid portion 74 closing the upper end of the inner cylindrical portion 73. A fluid passage 73a is formed along the inner periphery of the inner cylindrical portion 73. A distal end outer periphery 71a of the outer cylindrical portion 71 is press-fitted in the female press-fitting hole 62a. The seat member 70 is an inner member. The lid portion 74 is formed axially below the distal end of the outer cylindrical portion 71. The lid portion 74 has a communicating hole 74a formed in the center thereof to vertically extend therethrough. The lid portion 74 further has a spherical seat part 74b formed along the upper end edge of the communicating hole 74a. The seat part 74b has a tapered configuration in which the seat part 74b is gradually reduced in diameter toward the axis of the communicating hole 74a.

A valve spring 55 is compressively loaded between the lower end of the shaft portion 51 and an upper surface of the lid portion 74 at the outer periphery of the seat part 74b (this space will hereinafter be referred to as the “spring-accommodating space”). Accordingly, when the coil is not energized, the valve element 53 is separate from the seat part 74b, and the electromagnetic valve is open. The outer cylindrical portion 71 has an outer cylinder radial fluid passage 72 radially extending therethrough at a position axially overlapping the spring-accommodating space. The spring-accommodating space is formed at a position axially overlapping the second body 65, so that the outer cylinder radial fluid passage 72 and the second body radial fluid passage 200 communicate with each other.

When the coil is not energized, the brake fluid flowing in from the master cylinder-side fluid passage 100 passes through the filter member 80 before flowing into the fluid passage 73a. Thereafter, the brake fluid flows into the spring-accommodating space from the communicating hole 74a and flows out to the wheel cylinder-side fluid passage 300 via the outer cylinder radial fluid passage 72 and the second body radial fluid passage 200. On the other hand, when the coil is energized, the valve element 53 rests on the seat part 74b to cut off the fluid passage 73a and the spring-accommodating space from each other. Consequently, the master cylinder-side fluid passage 100 and the wheel cylinder-side fluid passage 300 are cut off from each other.

In the electromagnetic valve of the fourth embodiment, the outer cylindrical portion 71 of the seat member 70, which is the inner member, is formed thinner in sheet thickness than the electromagnetic valve body 60, which is the outer member. Accordingly, there is no need to ensure an extra sheet thickness, and it is possible to achieve size and weight reductions in the same way as in the first embodiment. In addition, it is possible to suppress the material cost when producing the electromagnetic valve and also possible to improve the ease of working. It should be noted that in the fourth embodiment the inner cylindrical portion 73, on which the seat part 74b is formed, constitutes a double-wall structure in cooperation with the outer cylindrical portion 71; therefore, the seat part 74b can be held even more stably, and a stable hydraulic pressure maintaining capability can be exhibited.

### Fifth Embodiment

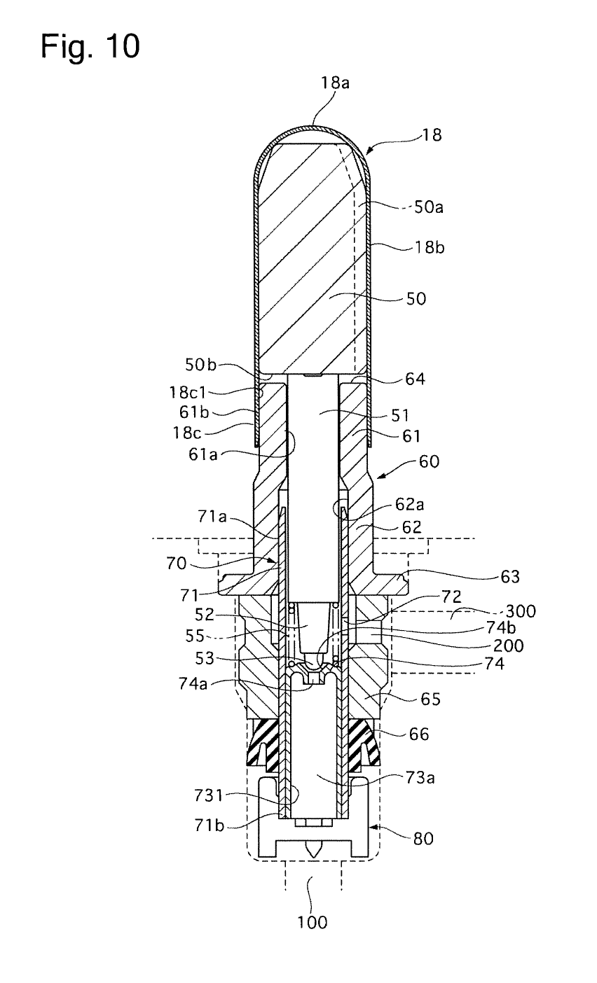

Next, a fifth embodiment will be explained. The basic structure of the fifth embodiment is the same as that of the fourth embodiment; therefore, only the points in which the fifth embodiment differs from the fourth embodiment will be explained. FIG. 10 is a sectional view of an electromagnetic valve of the fifth embodiment. In the fourth embodiment, the outer and inner cylindrical portions 71 and 73 of the seat member 70 are formed as one component part by folding back the same member; in the fifth embodiment, the outer cylindrical portion 71 and the inner cylindrical portion 731 are formed as two different members, and the inner cylindrical portion 731 is press-fitted to the outer cylindrical portion 71. In this point, the fifth embodiment differs from the fourth embodiment. The inner cylindrical portion 731 is formed thinner in sheet thickness than the outer cylindrical portion 71. In the fifth embodiment, the outer member comprises the outer cylindrical portion 71, and an opening 71b is formed at the other end of the outer member. The inner member comprises the inner cylindrical portion 731. Accordingly, there is no need to ensure an extra sheet thickness, and it is possible to achieve size and weight reductions in the same way as in the first embodiment. In addition, it is possible to suppress the material cost when producing the electromagnetic valve and also possible to improve the ease of working. Further, because the inner cylindrical portion 731, on which the seat part 74b is formed, constitutes a double-wall structure in cooperation with the outer cylindrical portion 71, the seat part 74b can be held even more stably, and a stable hydraulic pressure maintaining capability can be exhibited. Further, in the fifth embodiment, the inner cylindrical portion 731 is produced as a member separate from the outer cylindrical portion 71 in contract to the fourth embodiment, in which the outer cylindrical portion 71 and the inner cylindrical portion 73 are formed by bending one cylindrical member. Therefore, manufacture is facilitated, and it is possible to increase the accuracy of the seat part 74b and so forth formed on the inner cylindrical portion 731.

### Other Embodiments

Although the present invention has been explained on the basis of the embodiments, other structures are also included within the scope of the present invention. For example, although in the above-described embodiments the outer member and the inner member are each formed of a metal material, a resin material may be used to form each of the outer and inner members. Alternatively, the outer member may be formed of a metal material, and the inner member of a resin material. In this case, the sheet thickness of the inner member may be larger than that of the outer member, provided that the rigidity of the inner member can be set lower than that of the outer member.

(16-14) There is provided an electromagnetic valve comprising a coil generating a magnetic field when energized, a cylinder comprising a cylindrical member of a non-magnetic material disposed at the inner periphery of the coil, a core provided at one end of the cylinder, a valve element disposed in the cylinder movably in the axial direction of the cylinder so that one end of the valve element faces the core, the valve element having a valve part at the other end thereof, an outer member having a first cylindrical wall which is a cylindrical wall, the outer member being connected to the cylinder at one end thereof and having an opening at the other end thereof, and an inner member having a second cylindrical wall which is a cylindrical wall press-fitted to an inner surface of the first cylindrical wall at at least a part of an outer surface thereof formed at one end thereof, the inner member having at the other end thereof a seat part separable from the valve element, the inner member having a radial rigidity lower than that of the outer member. In the electromagnetic valve, the inner member and the outer member are formed of different materials from each other. Accordingly, it is possible to adjust rigidity on the basis of a factor other than the sheet thickness and hence possible to increase the degree of design freedom.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention. It is also possible to combine together the above-described embodiments as desired.

The present application claims priority to Japanese Patent Application No. 2014-186934 filed on Sep. 12, 2014. The entire disclosure of Japanese Patent Application No. 2014-186934 filed on Sep. 12, 2014 including specification, claims, drawings and summary is incorporated herein by reference in its entirety.

### REFERENCE SIGNS LIST

5; main passage 7; pressure-reducing valve 14; housing 15; valve holding hole 16; reduced-pressure passage 17; coil 18; cylinder 19; core 20; plunger 21; valve element 22; seat member 23; outer member 24; inner member 33; seat part 34; passage hole 42; valve spring 50; plunger 50a; core member 53; valve element 55; valve spring 60; electromagnetic valve body 62a; female press-fitting hole 70; seat member 71; outer cylindrical portion 73; inner cylindrical portion 74b; seat part 230; first cylindrical wall 240; second cylindrical wall 311; large-diameter portion 312; second cylindrical wall 321; small-diameter portion 331; seat part 332; seat part 731; inner cylindrical portion.

1. An electromagnetic valve comprising:
a coil that generate a magnetic field when energized; a cylinder of a non-magnetic material disposed at an inner periphery of the coil;
a core provided at a position facing the coil;
a valve element disposed in the cylinder movably in an axial direction of the cylinder so that one end of the valve element faces the core, the valve element having a valve part at an other end thereof;
a female press-fitting member having a first cylindrical portion connected to the cylinder; and
a male press-fitting member having a seat part capable of coming in and out of contact with the valve element, the male press-fitting member having a second cylindrical portion press-fitted at an outer surface thereof to an inner surface of the first cylindrical portion;
wherein the female press-fitting member has a rigidity lower than that of the male press-fitting member.

2. The electromagnetic valve of claim 1, wherein the female press-fitting member has a sheet thickness smaller than that of the male press-fitting member.

3. The electromagnetic valve of claim 2, wherein the female press-fitting member is formed by press-forming a sheet member.

4. An electromagnetic valve comprising:
a coil that generates a magnetic field when energized;
a cylinder of a non-magnetic material disposed at an inner periphery of the coil;
a core provided at a position facing the coil;
a valve element disposed in the cylinder movably in an axial direction of the cylinder so that the valve element faces the core, the valve element having a valve part;
an outer member having a first cylindrical wall, the outer member being connected to the cylinder side at one end thereof and having an opening at an other end thereof; and
an inner member having a second cylindrical wall press-fitted to an inner surface of the first cylindrical wall at at least a part of an outer surface thereof, the inner member further having a seat part separable from the valve element, the second cylindrical wall having a thin-walled portion thinner in wall thickness than the outer member.

5. The electromagnetic valve of claim 4, wherein the thin-walled portion is formed on at least a part of the second cylindrical wall.

6. The electromagnetic valve of claim 5, wherein the thin-walled portion is formed on a part of the second cylindrical wall that is to be press-fitted.

7. The electromagnetic valve of claim 6, wherein the thin-walled portion is formed on the second cylindrical wall in the circumferential direction thereof.

8. The electromagnetic valve of claim 4, wherein the inner member is formed by press-forming a sheet member.

9. The electromagnetic valve of claim 8, wherein the sheet member is work-hardened by press forming.

10. The electromagnetic valve of claim 4, wherein the inner member is reduced in rigidity in a compression direction of the inner member by the thin-walled portion.

11. The electromagnetic valve of claim 4, wherein the outer member and the inner member are formed from a same blank.

12. The electromagnetic valve of claim 4, further comprising:
an urging member compressively loaded between the valve element and the core to urge the valve element against the seat part;
the outer member being formed in a shape of a bottomed cylinder and connected to the cylinder at an opening end thereof, the outer member having a first fluid passage formed in a bottom portion thereof and a second fluid passage formed in a cylindrical wall thereof; and
the inner member being press-fitted at an outer surface thereof to an inner surface of the cylindrical wall of the outer member, the inner member having in a bottom portion thereof a communicating passage providing communication between the first fluid passage and the second fluid passage and further having on the bottom portion thereof a seat part with which the valve element is capable of coming in and out of contact to close and open the communicating passage.

13. An electromagnetic valve comprising:
a coil that generates a magnetic field when energized; a cylinder of a non-magnetic material disposed at an inner periphery of the coil;
a core provided at one end of the cylinder;
a valve element disposed in the cylinder movably in an axial direction of the cylinder so that one end of the valve element faces the core, the valve element having a valve part at an other end thereof;
an outer member having a cylindrical wall, the outer member being connected to the cylinder side at one end thereof and having an opening at an other end thereof; and
an inner member having a cylindrical wall press-fitted to an inner surface of the cylindrical wall of the outer member at an outer surface thereof formed at one end thereof, the inner member having at an other end thereof a seat part capable of coming in and out of contact with the valve element, the inner member having a radial rigidity lower than that of the outer member.

14. The electromagnetic valve of claim 13, wherein the cylindrical wall of the inner member has a thin-walled portion thinner in wall thickness than the cylindrical wall of the outer member.

15. The electromagnetic valve of claim 14, wherein the thin-walled portion is formed on at least a part of the cylindrical wall of the inner member.

16. The electromagnetic valve of claim 15, wherein the thin-walled portion is formed on a part of the cylindrical wall of the inner member that is to be press-fitted.

17. The electromagnetic valve of claim 13, wherein the inner member and the outer member are formed of different materials from each other.

18. The electromagnetic valve of claim 13, wherein the thin-walled portion is formed over an entire circumference of a part of the cylindrical wall of the inner member that is to be press-fitted.

19. The electromagnetic valve of claim 13, further comprising:
an urging member compressively loaded between the valve element and the core to urge the valve element against the seat part;
the outer member being formed in a shape of a bottomed cylinder and connected to the cylinder at an opening end thereof, the outer member having a first fluid passage formed in a bottom portion thereof and a second fluid passage formed in the cylindrical wall; and
the inner member being press-fitted at an outer surface thereof to an inner surface of the cylindrical wall of the outer member, the inner member having in a bottom portion thereof a communicating passage providing communication between the first fluid passage and the second fluid passage and further having on the bottom portion thereof a seat part with which the valve element is capable of coming in and out of contact to close and open the communicating passage.
